(19) United States
(12) Patent Application Publication
(10) Pub. No.: US 2016/0184836 A1
(43) Pub. Date: Jun. 30, 2016

(54) Separator

(71) Applicant: GEA Mechanical Equipment GmbH, Oelde (DE)

(72) Inventors: Wilfried MACKEL, Lippetal-Herzfeld (DE); Thomas BATHELT, Oelde (DE); Kathrin QUITER, Drensteinfurt (DE); Angelika VOLTMANN, Rheda-Wiedenbrueck (DE); Thomas HOMANN, Guetersloh (DE); Ulrich MEIER, Oelde (DE)

(21) Appl. No.: 14/411,335

(22) PCT Filed: Oct. 11, 2012
(86) PCT No.: PCT/EP2012/070182

§ 371 Date: Dec. 24, 2014

(30) Foreign Application Priority Data
Jun. 25, 2012 (DE) 10 2012 105 499.1

(51) Int. Cl. B04B 7/14; B01D 21/26; B04B 11/02

(52) U.S. Cl. CPC B04B 7/14; B04B 11/02; B01D 21/262

(57) ABSTRACT

A separator for the centrifugal separation of a flowable product into various phases or for the centrifugal clarification of a product includes a rotatable drum having a drum lower section and a drum upper section, a product clarifying arrangement arranged in the drum for clarifying a product to be treated in the centrifugal field. One or more, of all of the following elements are made from plastic or a plastic composite, the drum lower section, the drum upper section, the clarifying arrangement.

### BACKGROUND AND SUMMARY OF THE INVENTION

Exemplary embodiments of the present invention are directed to a separator.

Centrifugal separators for realizing a continuous operation have been known for a long time, separators of this type being known as nozzle separators in one embodiment from Japanese patent document JP 62-117649 A. Furthermore, U.S. Pat. No. 2,286,354 discloses a separator with solid drum lower sections and drum upper sections that are bolted together. In addition to nozzle separators, there are also known separators of this type with solid-material discharge openings with which is associated a hydraulically operable piston slide valve by means of which the solid-material discharge openings can be closed and opened. As a separator, U.S. Pat. No. 2,017,734 discloses a design of a separator without solid-material discharge.

In the case of centrifuges of the known type of construction, the demand exists for new constructional methods especially with regard to the processing of products under hygienic conditions.

In accordance with exemplary embodiments of the present invention, separation of a free-flowing product into different phases or for the clarification of a product is achieved using a separator having at least the following features: a rotatable drum with a lower section and an upper section and a means for clarification arranged in the drum, wherein one, a plurality, or all of the following elements consist of plastic or a plastic-composite material: the drum lower section, the drum upper section and the means for clarification.

The means for the clarification of a product to be processed—to be clarified—of solid material particles is preferably a separating plate packet consisting of conical separating plates consisting of plastic, but can also be for example a one-piece clarification/separation cartridge consisting of plastic in the manner of DE 10 2008 052 630 A1 or another means for the clarification of a product of solid material particles such as a finned body with radial fins or the like.

Accordingly, some, and preferably even all, of the product-contacting regions of the rotating system consist of plastic or a plastic-composite material, especially the drum lower section and the drum upper section and the plate packet. Especially preferably, the feed system and the discharge system also consist of plastic or a plastic-composite material.

In such a way, it is possible to design a part of the drum or preferably even the entire drum—preferably in addition to the feed and discharge systems or regions—for a one-time application, which is of interest and advantage especially with regard to the processing of pharmaceutical products such as fermentation broths or the like since, after the operation for the processing of a corresponding batch, no cleaning of the drum is to be carried out during operation which is preferably continuous during the processing of the batch, but rather the drum is to be exchanged as a whole. Problems of hygiene associated with cleaning are excluded in a simple manner as a result of this. The product-contacting parts can be entirely disposed of or recycled. The disposal is also of interest especially in the case of hazardous substances.

It is also conceivable, during a clarification process of a product, to concentrate very dense substances and to melt down the drum after the processing of a batch, or, for example, to dissolve the drum in an acid or the like in order to produce the dense substance as a residue of this process.

By using plastic parts, the production costs can be kept relatively low, moreover.

The drum can preferably be rotated by means of a spindle construction that preferably consists of plastic or a plastic-composite material and which is preferably coupled directly to the output shaft of a motor, wherein the spindle construction has no rotational bearings on its outer circumference. This construction is simple and robust and very well suited to the lightweight drum construction. The electric motor or its rotor bearing arrangement undertakes the function of the bearing of the drum in a simple manner.

It is advantageous and particularly hygienic in this case if the entire drum, especially also its feed system and its discharge system, is/are designed as a sealed type of construction.

According to an advantageous development, the drum is enclosed by a housing that preferably also consists of plastic or a plastic composite material. It is even possible that the entire separator, apart from the motor, consists of plastic so that apart from the motor it can preferably be exchanged as a whole as a preassembled unit.

According to an especially advantageous development of the invention, the drum lower section is provided directly in one piece with a distribution attachment having one or more distribution channels for transferring the product to be processed from a feed pipe into the drum interior. In such a way, two components or even sub-assemblies, which otherwise are to be produced separately, are combined, which especially enables the production from plastic.

A recyclable plastic, especially PE (polyethylene), PP (polypropylene), or TK-PEEK (especially partially crystalline polyethereretherketone), is preferably used as the plastic.

The parts consisting of plastic can be produced in an injection molding process and, if applicable, are aftermachined, e.g. are provided with holes or the like, where it is necessary.

Screws and the like can also consist of plastic but they can also be produced from another material, especially if they do not come into contact with the product.

An operation of the rotating system at sub-critical rotational speeds (below the first resonance frequency of the rotating system) appears to be especially advantageous since such a drive simplifies the drive system considerably and due to the material selection this separator, in contrast to other currently common separators, is operated in other rotational speed ranges.

The power demand can usually be reduced compared with existing constructions. As a result of the low rotational speed, the noise emission is corresponding low.

A use of a separator according to the invention as a disposable separator for the one-time processing of a product batch is also created by means of the invention, wherein the separator, without the drive, is preferably disposed of after the processing of this product batch, for example by professionally conducted incineration, for example, in order dispose of hazardous materials, for example.

The invention also provides a method for operating a separator according to the invention. With this method, substances that collect in the drum interior in the region of the largest inside circumference are concentrated during a clarification process of a product. The drum is then disintegrated after the processing of a batch—for example incinerated or melted down or, for example, dissolved in an acid or the like—in order to produce the dense material as a residue of this process.

If solid materials are densely compacted so that they cannot be discharged, or discharged only with great difficulty, or clog or block the solid-material discharge holes, it is possible to release or to re-dilute the solid materials from time to time, or when necessary, via the discharge system (diverter and possibly holes in the drum cover) by short-term flushing with a medium (water, clarified product, buffer solution) so that these solid materials can still be discharged via the emptying holes.

### BRIEF DESCRIPTION OF THE DRAWING FIGURE

The invention is described in more detail below based on exemplary embodiments with reference to the figures. In the drawing:

FIG. 1 shows a view of a separator according to the invention with a direct drive and with a housing and drum shown in section.

### DETAILED DESCRIPTION

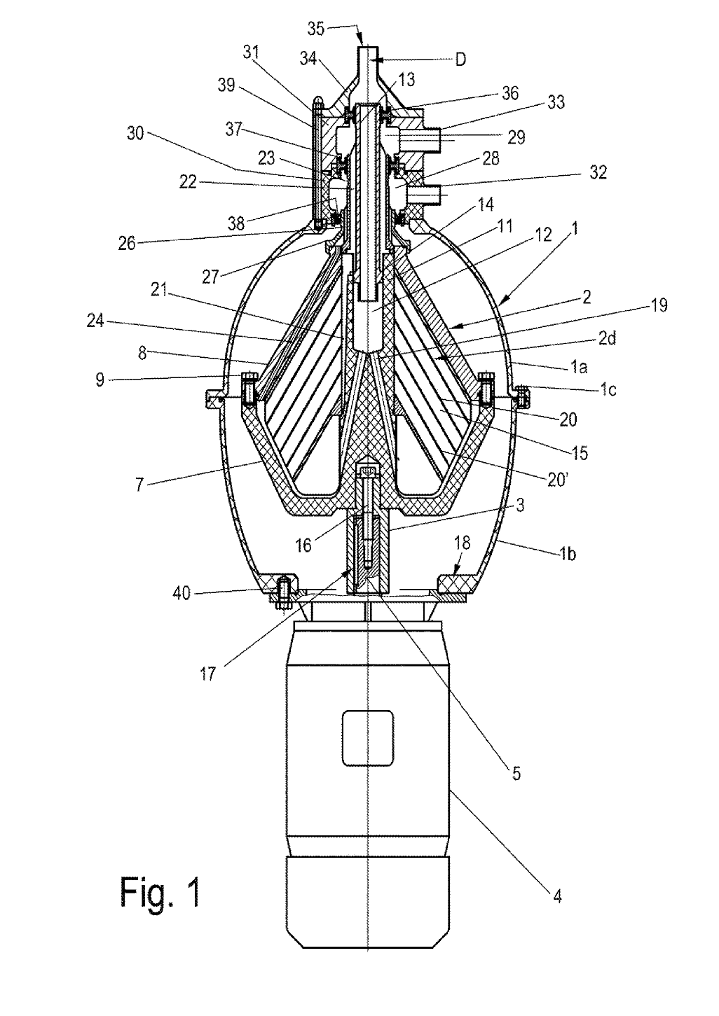

FIG. 1 shows a section through the region of the housing 1 and the drum 2 of a separator according to the invention, by means of which a liquid product can be separated in the centrifugal field into two phases. The housing 1 has an (almost a hemispherical segment-like) upper section 1a and a corresponding lower section 1b, which in this case by way of example are connected by screws 1c to a flange section. The housing can consist of plastic or a plastic-composite material.

The drum 2 has a vertical rotational axis D and in this case is mounted on a driving—in a simple type of construction here—sleeve-like spindle construction 3 that is coupled directly, or via interposed transmission elements, to a drive motor 4.

A particularly compact design is achieved if the drive motor is an electric motor 4 arranged directly in the axial extension of the spindle construction 3, preferably on the side of the spindle construction 3 facing away from the drum.

In this case, the spindle 3 is connected axially to an output shaft 5 directly by a bolt 16. It is also connected in a rotation-resistant manner in the circumferential direction to the output shaft 5 of the electric motor 4 by means of a torque transmission means, in this case a feather key 17. The torque transmission means can also be designed in another form, for example as a torque transmitting contour (not shown here).

The rotatable drum 2 can be connected to the drive spindle construction 3 by a press fit (e.g. in a conical section) or by means of another torque transmission means (not shown here).

In this case a separate bearing arrangement of the spindle construction 3 is preferably dispensed with, which makes the construction able to be realized in simple and relatively cost-effective manner. Instead, the bearing arrangement of the output shaft 5 in the motor housing 6 of the electric motor 4 also serves, preferably directly, as the bearing arrangement of the entire rotor systems consisting of output shaft 5, spindle construction 3 and drum 2.

The motor 3, on its side facing the spindle 3, is furthermore fastened on a flange section 18 of the housing 1 in this case, for example being screwed on by threaded bolts 40. The housing or the flange section can in turn be fastened in a way not shown here—for example by a screw fastening—on a base or machine frame or the like, which is not shown here.

The drum 2 has a conical lower section 7 and a conical upper section 8 so that altogether a double-cone body is formed. The drum lower section 7 and the drum upper section 8 are bolted together, preferably in the region of their largest circumference, by means of circumferentially distributed threaded bolts 9. The connection could also be achieved in another way, however, for example by a type of bayonet joint between the two parts or by a screwed fastening in the form of a separate locking ring, similar to separators consisting of metal. Also conceivable would be a tri-clamp connection (ring clamped by conical surfaces). Also conceivable would be a type of spring ring for securing the one drum section in the other.

Axially adjoining one part—in this case the lower part 10—of the drum lower section 7 in one piece is a distribution attachment 11 that coaxially encompasses the rotational axis and forms a complete distributer for introducing the material to be centrifuged into the drum interior 15 and for accelerating the material to be centrifuged in the circumferential direction during rotations of the drum 2.

Formed in the distribution attachment 11, in the upper region, is a blind hole-like bore 12 into which opens a feed pipe 13. The feed pipe is sealed by its outside circumference against the inside circumference of the bore 12 by a first circumferential seal (e.g. an O-ring) 14.

The feed pipe 13 and the distribution attachment 11 form in such way advantageously provide a feed system sealed against the environment.

At its lower end, the bore 12 also opens into one or more distribution channels 19 that are formed at an angle to the rotational axis and in this case also open at an angle into the actual drum interior 15.

Arranged in the drum interior 15 are means for clarification such as especially a one-piece or preferably multi-piece plate packet 20 is formed as a stack of axially spaced apart separating plates 20′ having a conical basic shape and which are preferably mounted in a rotation-resistant manner on the distribution attachment 11. The means for clarification could also be designed in another form, such as a finned body with radial or arc-shaped fins or as a clarification cartridge with clarifying chambers.

The separating plates 20′ in this case preferably have different radii in each case, which is brought about by the conical basic shape of the drum lower section 7 because the separating plates 20′ preferably extend outward until just before the inner edge of the drum lower section 7 so that its diameter correspondingly reduces from the top downward.

A product introduced into the drum interior 15 is separated in the drum 2 into different, preferably two, product phases of different density.

Serving for the discharging of the different product phases from the drum 2 is a discharge system with two or more discharge regions.

In this way, a lighter liquid phase flows radially inward and in a channel 21 on the distribution attachment 11 is directed there axially upward into an annular channel 22 formed between the outside circumference of the feed pipe 13 and a pipe section 23 of larger diameter which also projects into the drum 2 from the top.

A denser liquid phase (or a solid phase that is still not free flowing), on the other hand, is directed from the region of the largest inside circumference of the drum interior through a channel 25 in the drum upper section 8, in fact preferably into a second annular channel 26 between the outer pipe section 23 and a drum cover 27, which preferably also consists of plastic.

The denser and the lighter liquid phases flow out of the annular channels 22, 26 towards the top in each case into annuluses 28, 29, arranged axially one above the other, in annular bodies 30, 31 which are provided with radial discharge pipes 32, 33 through which the lighter and denser phases discharged from the drum can be further discharged. Towards the top, an annular cover 34, with a through-hole 35 for introducing liquid into the feed pipe 13, is arranged on the annular body 33. The elements 30, 31, 34 also preferably consist of plastic.

A first ring seal 36 is arranged between the inner feed pipe and the annular body 31 or the cover 34. A further ring seal 37 is also arranged between the outer pipe section 23 and the annular body 31. Moreover, a further ring seal 38 is arranged between the cover 27 and the lower annular body.

The housing 1, the annular bodies 30, 31 and the cover 34 are compactly and reliably axially clamped together in this case in a simple manner by one or more bolts, especially threaded bolts 39.

The feed system and also the discharge system with the at least two discharges, and therefore the entire drum 2, are preferably of a hermetically sealed design, especially in the featured way or in another way, so that the product does not come into contact with the environment of the drum and is pressurized by the rotating system.

In this case, some, or preferably even all, of the product-contacting regions of the rotating system consist of plastic or a plastic-composite material, especially the drum lower section 7 and the drum upper section 8. The separating plates 20 especially preferably also consist of plastic as well as all of the product-contacting regions of the feed system and the discharge system, even if these do not rotate during operation.

It is also possible and advantageous, however, to produce the housing 1 from plastic or from a plastic-composite material.

In such way, the construction is very light and can be disposed of after the processing of a sufficiently large product batch.

FIG. 1 shows an embodiment as a two-phase separating machine (separation of a product into “liquid/liquid” phases), wherein the second liquid phase is discharged through the drum cover 8.

Three-phase machines (for separation into three phases) can also be realized (not shown here).

The entire drum 2, in addition to the feed system and discharge system and possibly a part of the housing 1—the housing upper section 1a—is advantageously and simply designed as an exchangeable preassembled module consisting of plastic or a plastic-composite material.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof

List of designations

| | |
|---|---|
| Housing | 1 |
| Housing upper section | 1a |
| Housing lower section | 1b |
| Screws | 1c |
| Drum | 2 |
| Spindle | 3 |
| Drive motor | 4 |
| Output shaft | 5 |
| Motor housing | 6 |
| Drum lower section | 7 |
| Drum upper section | 8 |
| Threaded bolt | 9 |
| Section | 10 |
| Attachment | 11 |
| Bore | 12 |
| Sealing material | 14 |
| Feed pipe | 13 |
| Circumferential seal | 14 |
| Drum interior | 15 |
| Bolt | 16 |
| Feather key | 17 |
| Flange section | 18 |
| Distribution channels | 19 |
| Plate packet | 20 |
| Separating plates | 20′ |
| Channel | 21 |
| Annular channel | 22 |
| Pipe section | 23 |
| Channel | 25 |
| Annular channel | 26 |
| Drum cover | 27 |
| Annuluses | 28, 29 |
| Annular bodies | 30, 31 |
| Discharge pipes | 32, 33 |
| Cover | 34 |
| Through-hole | 35 |
| Ring seal | 36 |
| Ring seal | 37 |
| Ring seal | 38 |
| Threaded bolt | 39 |
| Threaded bolt | 40 |

1-21. (canceled)

22. A separator for the centrifugal separation of a free-flowing product into different phases or for the centrifugal clarification of a product, the separator comprising:
a rotatable drum with a drum lower section and a drum upper section; and
a means arranged in the drum for clarifying a product processed in a centrifugal field of the separator,
wherein at least one of the following elements consists of plastic or a plastic-composite material
the drum lower section,
the drum upper section,
the means for clarification.

23. The separator of claim 22, wherein the means for clarification is a plate packet consisting of a stack of separating plates.

24. The separator of claim 22, wherein one or both of the drum upper section and the drum lower section have a conical design.

25. The separator of claim 22, wherein the drum is rotatable by a spindle arrangement consisting of plastic or a plastic-composite material.

26. The separator of claim 25, wherein spindle arrangement is coupled directly to an output shaft of a motor and the spindle arrangement does not have rotational bearings on its outside circumference.

27. The separator of claim 22, wherein the drum, a drum feed system, and a drum discharge system has a sealed construction.

28. The separator of claim 22, wherein all product-contact regions of the drum consist of plastic.

29. The separator of claim 22, wherein the drum is enclosed by a housing consisting of plastic.

30. The separator of claim 22, wherein the entire separator, apart from a motor, consists of plastic.

31. The separator of claim 22, wherein the drum lower section is provided directly in one piece with a distribution attachment having distribution channels configured to transfer the product to be processed from a feed pipe into an interior of the drum.

32. The separator of claim 29, wherein the entire drum, including a feed system, discharge system, and a part of the housing, is an exchangeable preassembled module consisting of plastic or a plastic-composite material.

33. The separator of claim 22, wherein the entire separator, except for a motor, is an exchangeable preassembled module consisting of plastic or a plastic-composite material.

34. The separator of claim 29, wherein a motor is flanged directly onto the housing.

35. The separator of claim 27, wherein product-contacting sections of the discharge system consist of plastic.

36. The separator of claim 22, wherein the drum upper section includes an integrated discharge channel for a dense product phase.

37. The separator of claim 27, wherein discharge regions of the discharge system are annular channels opening axially into annuluses in annular bodies.

38. The separator of claim 37, wherein the annular bodies consist of plastic or a plastic-composite material.

39. The separator of claim 22, wherein the upper drum section includes an integrated discharge channel for a product phase.

40. The separator of claim 22, wherein a drum cover consisting of plastic is mounted on the drum upper section.

41. A method for operating a separator for the centrifugal separation of a free-flowing product into different phases or for the centrifugal clarification of a product, the separator comprising a rotatable drum with a drum lower section and a drum upper section, a means arranged in the drum for clarifying a product processed in a centrifugal field of the separator, wherein at least one of the following elements consists of plastic or a plastic-composite material the drum lower section, the drum upper section, the means for clarification, the method comprising:
concentrating a product of very dense substance during a clarification process; and
melting down the drum or dissolving the drum in acid after the processing of a batch in order to produce the dense substance as a residue of this process.
